(19) United States
(12) Patent Application Publication
(10) Pub. No.: US 2007/0226131 A1
(43) Pub. Date: Sep. 27, 2007

(54) DATA PROCESSING METHOD AND APPARATUS FOR MITIGATING RISK IN FINANCING PURCHASES OF GOODS INCLUDING BUT NOT LIMITED TO AUTOMOBILES

(76) Inventors: Katherine K. Decker, Atlanta, GA (US); Sam Evans, Nashville, TN (US); Mark Brunn, Nashville, TN (US)

Correspondence Address: NIXON & VANDERHYE, PC, 901 NORTH GLEBE ROAD, 11TH FLOOR, ARLINGTON, VA, 22203, US

(21) Appl. No.: 11/681,541

(22) Filed: Mar. 2, 2007

Related U.S. Application Data
(60) Provisional application No. 60/780,369, filed on Mar. 9, 2006.

(51) Int. Cl. G06Q 40/00

(52) U.S. Cl. 705/38

(57) ABSTRACT

An electronic data processing risk mitigation clearinghouse can assure a lender that a given independent dealer transaction will be handled in a regular, orderly way and that the lender's dealer risk is mitigated. The lender can be assured that loans will not originate from unduly risky dealers, and that liens or other security interests in vehicle or other goods will be perfected in a timely and efficient manner. Dealers, including independent dealers without existing relationships with full credit spectrum of lenders, can now offer their customers a range of financing options not previously available. Consumers who decide to purchase through independent dealers based on convenience, inventory or other reasons can choose from a wider range of different financing options. Consumers may receive more competitive interest rates, better loan terms or other benefits as a result.

### CROSS-REFERENCES TO RELATED APPLICATIONS

This application claims the benefit of priority from provisional application No. 60/780,369 filed Mar. 9, 2006, incorporated herein by reference.

### TECHNOLOGICAL FIELD

The technology herein relates to data processing, and more particularly to automated computer systems for processing transactions and mitigating risk. Still more particularly, the technology herein relates to a method and apparatus for providing independent and other dealers with sources of retail financing using a clearinghouse to reduce or mitigate risk to lenders in real time or substantially real time.

### BACKGROUND AND SUMMARY

Consumers today have a wider range of car buying options than ever before. New cars offer the latest in safety, performance and style. However, not everyone can afford a brand new car. Some do not want to spend the money to purchase the latest model, but would be content with a pre-owned car of known condition and ownership.

For the pre-owned car market, there are a wide range of consumer choices and options. Many new car dealers sell pre-owned cars they obtain from fleet operators or trade-ins. Car dealers also can purchase quality pre-owned cars through a network of automobile auctions. Manheim is an example of one such auction operator. Independent car dealers typically don't receive many trade-ins as payment on another vehicle. They therefore typically rely heavily on such auctions to obtain inventory to sell to their customers.

It is rare for customers to pay cash for new or pre-owned car purchases. Most folks need to take out a loan to buy cars and other expensive items. Consumers benefit from a wide range of financing options and lender choices. Consumers can obtain financing through their own efforts or utilize a dealer at time of purchase. Large, well-established franchised car dealers generally have no problem offering a wide spectrum of financing options to their buyers. Many such dealers have good relationships with a network of nationwide lenders. Larger (e.g., franchise) lenders generally rely on backing of the car manufacturers and relatively high education, net worth and other qualifications of franchise dealer owners to reduce transaction risk.

Smaller and/or independent car dealers face a different set of challenges when seeking financing relationships with lenders. Such independent dealers often do not have existing relationships with nationwide lenders. Lenders may be wary about disbursing funds to independent dealers they don't know. The diversity of independent dealers makes risk management more difficult for lenders. For example, lenders may not trust independent dealers to do the necessary paperwork in a regular and timely manner. It is not unknown for independent dealers to go out of business without recording outstanding liens. Some independent dealers have engaged in sham transactions. After a few bad experiences, some lenders have decided to reduce their risks by limiting their transactions to larger dealer franchises. Such decisions, while eminently reasonable, have the effect of reducing the choices and convenience available to prospective car buying consumers. Consumers suffer as a result.

It would therefore be highly desirable to provide efficient mechanisms for giving consumers a wider range of lender choices and options while minimizing lender risks and maximizing transactions efficiently.

The technology herein provides risk mitigated solutions, systems methods and environments that use modern computers and associated networks in ways that are highly efficient, cost-effective, timely, robust and reliable for coordinating and clearing lender transactions including but not limited to automobile purchases.

Through use of the exemplary illustrative non-limiting implementations herein in conjunction with relationships in the industry, a clearinghouse can assure a lender that a given independent dealer transaction will be handled in a regular, orderly way and that the lender's dealer risk is mitigated. As one example, the lender can be assured that loans will not originate from unduly risky dealers, and that liens or other security interests in vehicle or other goods will be perfected in a timely and efficient manner. Dealers, including independent dealers without existing relationships with full credit spectrum of lenders, can now offer their customers a range of financing options not previously available. Consumers who decide to purchase through independent dealers based on convenience, inventory or other reasons can choose from a wider range of different financing options. Consumers may receive more competitive interest rates, better loan terms or other benefits as a result. Lenders receive good business they would otherwise not participate in, at the same time controlling their risk.

One aspect of the exemplary illustrative non-limiting technology herein leverages relationships and information with independent dealers to reduce risk and make transactions more efficient. Leveraging relationships with independent dealers to collect risk related information can reduce risks to lenders—allowing transactions to proceed that might not otherwise be possible, practical and/or convenient.

As one non-limiting example, if an independent dealer falls out of trust with one aspect of the network (e.g., by failing to provide a payment, failing to meet other requirements for a transaction to proceed in a timely manner or changing behavior in various ways), the network mitigates risk by restricting and/or preventing that dealer from participating in other aspects of the network operation.

In one non-limiting example, the system can close dealer access to financing portals in real time response to a risk mitigation determination. For example, an inventory/financing supply portion of the system can be used to collect information about independent dealers. The people who are dealing with the independent dealer every week to supply him or her with inventory or financing will often know if the dealer is having problems that may affect his or her ability to pay or complete transactions. Furthermore, the dealers are often comfortable with and trust the people they look to for inventory/financing supply.

In some cases, an existing computerized inventory database derived from auction activities and existing relationships between auction houses and floorplan companies may be maintained. If such information gathering and collection reveals such problems exist, the system can automatically mitigate risk to lenders in real time by preventing further transactions from occurring. The system allows such warning flags indicating problems to be generated electronically in real time or close to real time, thereby propagating through the system and providing rapid notification of potentially risky transactions that should be avoided. The dealer cannot remain in business without a source of inventory and inventory financing, so inventory supply is an efficient and reliable way to keep tabs on dealers. Such relationships can be powerful inducements to ensure that a diverse group of independent dealers comply with transactional requirements.

Additional exemplary non-limiting features and advantages include:
Real time or near real time capability to restrict access to financing portal system for dealers not maintaining “active/good” status
Direct communication link with the program lender's loan origination system for the program to track status of program loans.
   Communication of approved loans to clearinghouse triggers a file from portal (e.g., connected to loan origination system) indicating a contract has been booked by a lender
   On-going monitoring and data collection of dealer risk by floorplan audits, curtailments, “local knowledge”, annual review, other
Clearinghouse can complete transactions in a regular and orderly way by receiving funds directly from platform lenders and disbursing to the following sources:
   A) Respective floor plan bank auction for floor plan payoff
   B) Insurance and Service Contract provider for payment of respective products sold from the program platform
   C) State titling and registration entities for vehicle transfer and lien perfection on behalf of all involved parties
   D) Other
Clearinghouse can contact financial entities associated with trade-in vehicles maintaining a title lien to confirm that program dealers have completed the trade-in vehicle payoff process or payoff trade by adding it to dealer's floorplan line of credit (make sure trade-in has been paid)
Central Title System can record and track title, registration, and lien responsibilities associated with ownership transfer of program cars via a task-based computer program
   A) Title System communicates with clearinghouse to receive assignments and basic data
   B) Title System is driven by employees working through a progression of action steps programmed into the Title System via a series of action prompt flags leading employees through the completion of the title, registration, and lien aspects for program cars.
   C) Title System maintains capability of generating date sensitive reports which identify delinquent title, registration, and lien completion for program cars.

One method of obtaining access is through qualifying for a floorplan account. The qualifying process involves thorough due diligence on the dealer. Some of the items dealers are screened for may include:
financial stability
industry experience
credit-worthiness
other
Titles guaranteed to be received within 90 days or clearinghouse purchases the loan off the lender's books

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows an exemplary illustrative non-limiting risk mitigation system and method;

FIG. 1A is a block diagram of an exemplary illustrative more detailed non-limiting data processing risk mitigation system; and

FIGS. 2A-2D are together a flowchart showing an exemplary illustrative non-limiting process map for dealer auto funding solutions.

### DETAILED DESCRIPTION

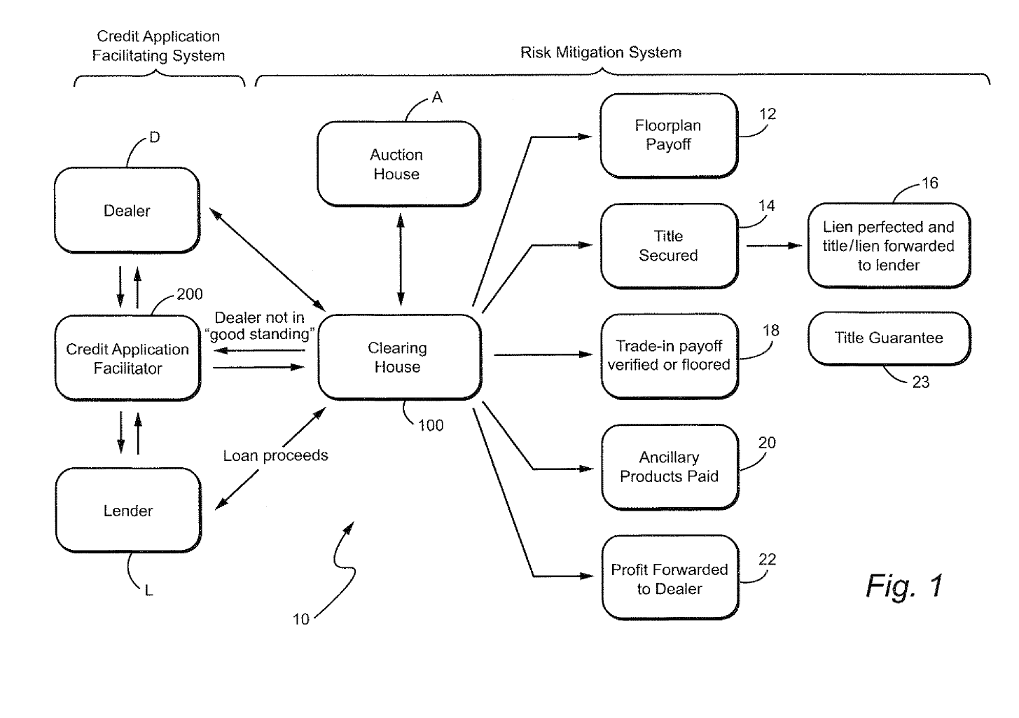

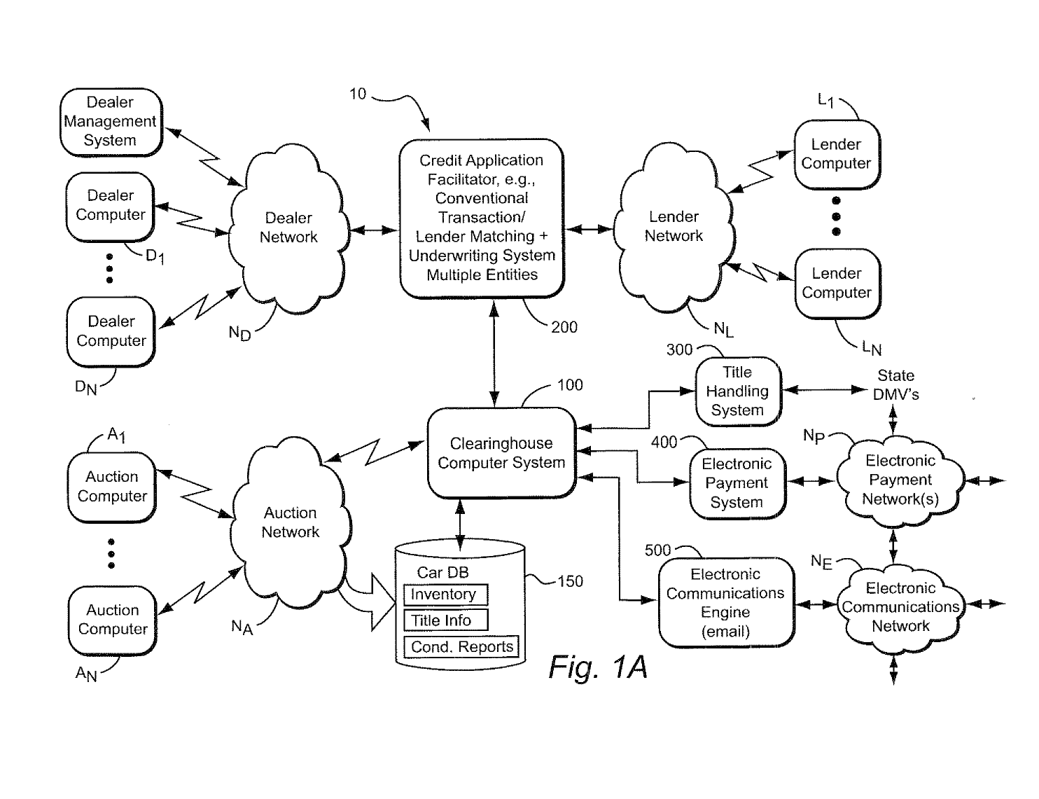

FIG. 1 shows an exemplary system 10 for providing dealer funding for the purchase of automobiles or other items. System 10 includes credit application fulfillment system and a risk mitigation system, the risk mitigation system may include a clearinghouse (“CH”) 100 that may consist of or comprise a data processing system such as a main frame or mini computer. Clearinghouse 100 communicates electronically with a credit facilitator (e.g., transaction/lender matching) engine 200 of conventional design. Clearinghouse 100 and engine 200 can communicate with at least one lender L and at least one dealer D. In one exemplary non-limiting implementation, clearinghouse 100 may also communicate with an auction house A.

In the exemplary illustrative non-limiting implementation, the clearinghouse 100 maintains a “good standing” flag or value for each dealer. This “good standing” flag or value is an indication of the amount of risk associated with conducting transactions through that dealer. Through local dealer relationships and/or automatically, clearinghouse 100 collects information relevant to that “good standing” flag for each of the dealers in the dealer network. Such information is preferably collected in real time or close to real time in the exemplary illustrative non-limiting implementation. An evaluator adjusts the value of the “good standing” flag based on perceived risk factors. If the “good standing” flag or value indicates a particular dealer is not in “good standing” (i.e., there is undue risk or uncertainty associated with the dealer), then clearinghouse 100 communicates this information to lenders. This can, for example, have the effect of closing access by the dealer to loan origination system portals (e.g., by revoking the dealer's password).

Credit facilitator engine 200 may, for example, match prospective buyers of automobiles or other goods with lenders L willing to finance such transactions. Clearinghouse 100 also performs a variety of tasks in support of such financing transactions, including for example:
paying off loans associated with items already sold (block 12)
securing title to the item, perfecting a lien to the lender and forwarding the title/lien to the lender (blocks 14, 16, 23)
verifying trade-in payoff (if any) (block 18)
paying ancillary products such as insurance, extended warranties, etc. (block 20)
forwarding profits to the dealer (block 22).

By positioning clearinghouse 100 between the lender network and the dealer network, the clearinghouse can insulate and/or mitigate the lender L from risk and regularize transactions for a diverse set of independent and other dealers D.

FIG. 1A shows an exemplary more detailed block diagram of an exemplary illustrative non-limiting system 10. In the exemplary system shown, clearinghouse computer system 100 may communicate with one or a plurality of dealer computers D₁, D_{N} via a dealer network N_{D}; and with one or a plurality of lenders L₁, L_{N} directly or indirectly through plurality of lender matching underwriting system 200 via a lender network N_{L}. Such dealer computers D₁, D_{N} can be dealer management systems or other types of computing systems.

In one exemplary non-limiting implementation, the clearinghouse can communicate with one or a plurality of auction house computers A₁, A_{N} via an auction network N_{A}. While FIG. 1A shows three separate networks N_{D}, N_{A}, N_{L}, such networks can all comprise the same overall communications network such as for example the Internet or other network(s) capable of communicating messages using the Internet Protocol (IP) or other messaging protocol.

In one exemplary illustrative non-limiting example shown, clearinghouse computer system 100 is also able to directly or indirectly access a database(s) 150 storing information about cars or other items. Such information may, for example, be derived or obtained from auction houses A that sell items to dealers D, from dealer management systems on site at dealer facilities (either directly or via financing portals), etc. Information maintained by database(s) 150 can include, for example, inventory information for each dealer D (i.e., what inventory the dealer actually has “on the floor”), title information concerning items for sale; condition reports; and other information. Such information can be used for example to collect additional information about dealers (e.g., by reviewing their floor plans).

Clearinghouse computer system 100 in this illustrative non-limiting implementation may also communicate with an automated title handling system 300 that is capable of efficiently and timely recording titles for liens with governmental authorities such as the Motor Vehicle Departments of all 50 States of the United States. Clearinghouse computer system 100 may communicate with an automated electronic payment system 400 that can receive, disburse and otherwise distribute payments between various entities (lenders L, dealers D, auction houses A) via an electronic payment network and can bill dealers and lenders.

Clearinghouse 100 may also communicate with a conventional electronic communications engine 500 such as an email engine to distribute communications and documents via an electronic communications network N_{E} (which may be the same or different network from the other networks shown).

Generally, matching/underwriting system 200 may match dealers and their customers with lenders, communicate and execute lending transactions, and initiate certain inquiries or transactions. The internal operations of conventional transaction/lender matching and underwriting system 200 are not a part of the invention.

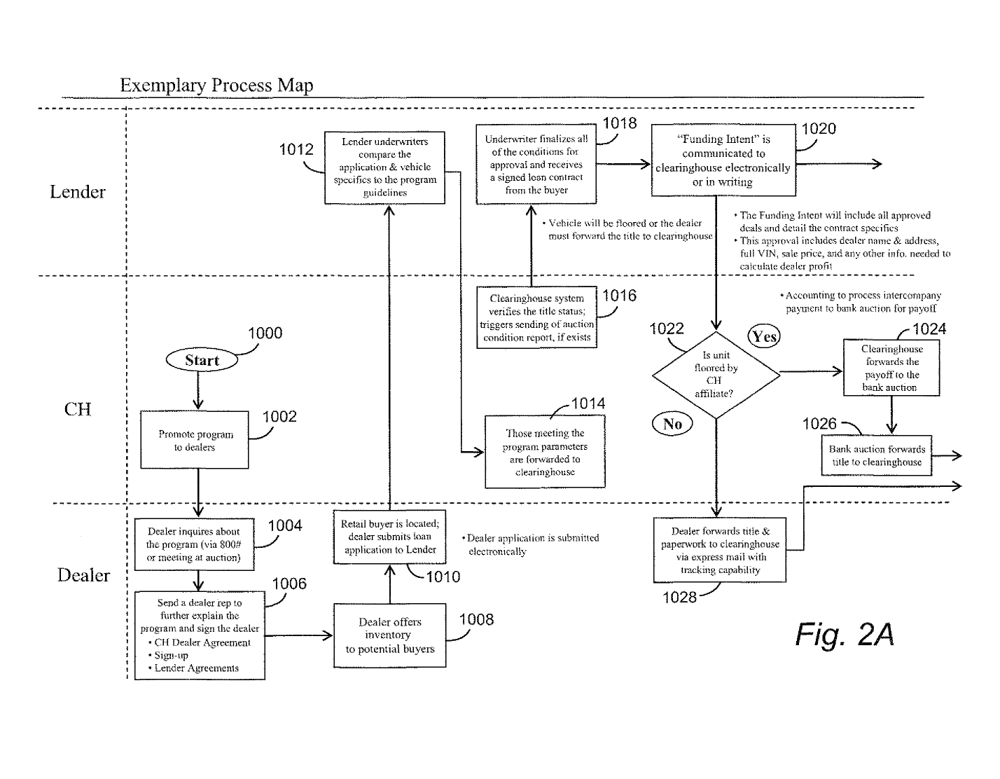

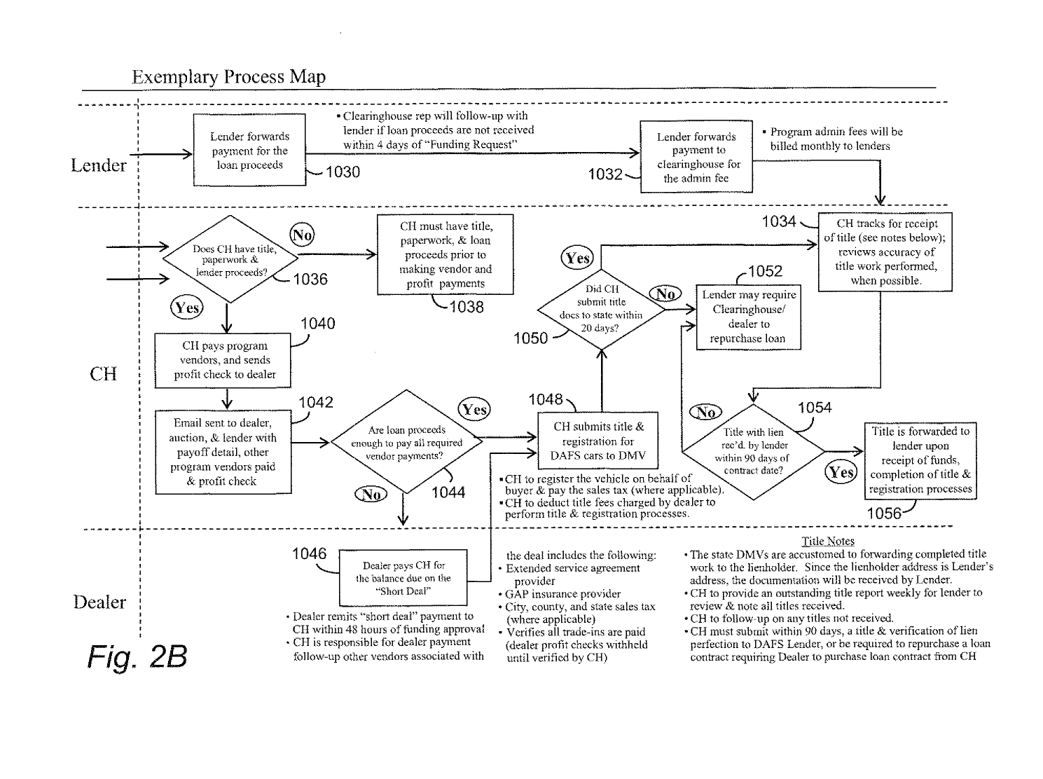

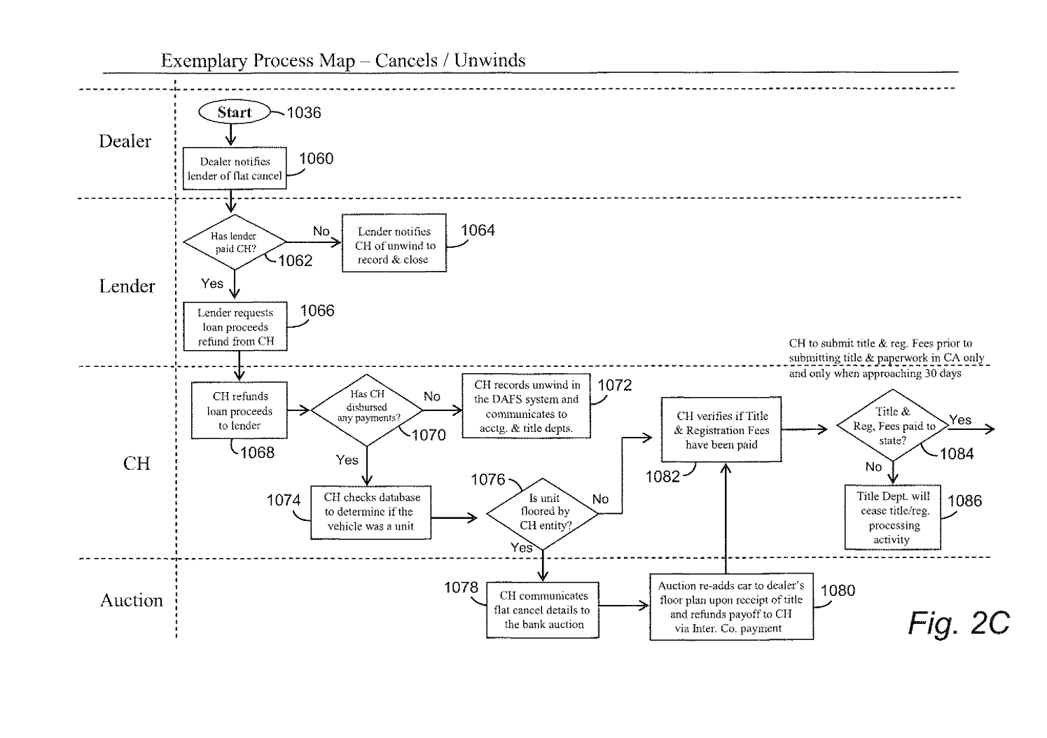

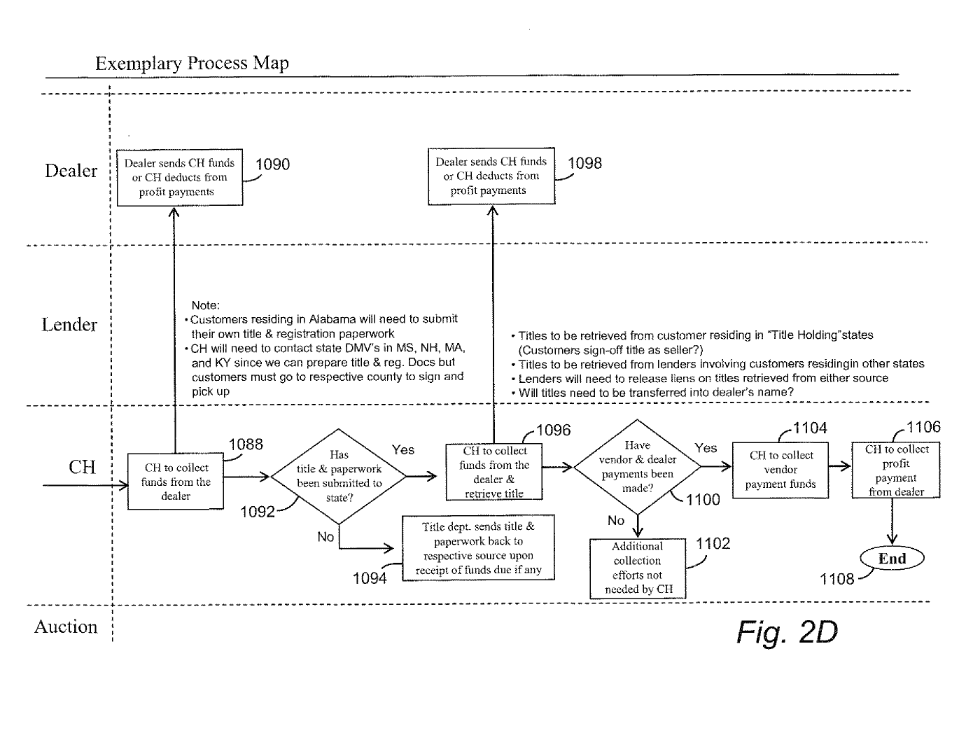

FIGS. 2A-2D show an example illustrative non-limiting process map for providing dealer auto funding solutions using a computer platform. Further details are as follows:

Exemplary Illustrative Non-Limiting Financial Facilitator and Risk Mitigation Process Flow

Exemplary Lender Setup

Lenders L are solicited via presentations conducted by clearinghouse or jointly by clearinghouse and portals (block 1002) or through the clearinghouse 100.
Lenders L will receive a marketing campaign detailing the program (block 1002).
Lenders are solicited via presentations conducted by clearinghouse or jointly by clearinghouse and portal.
Lenders L are provided with agreements for their review and signature.
Follow-up for signed contract to be completed by the clearinghouse management or representatives.
The signed contract from the lenders is received
The signed contract is imaged into the appropriate database.
Forward an e-mail notification to the Help Desk for system and JDE setup.
Help Desk forwards an e-mail indicating the process has been completed and providing the lender's ID.
   Exemplary Dealer Setup
Solicit dealers through an auction visit, promotions by sales force or auction sales, or interested dealers will contact a toll free number requesting information about the program (block 1004).
“In network” dealers with floor plans of sufficient size are sent an invitation to attend a presentation at their home auction (block 1004).
Follow up calls are made to dealers and visits made to encourage dealers to sign up with the program and have the agreement completed during their visit (block 1006).
The signed agreement may include a signed and notarized power of attorney, W-9, dealer's license, and completed EFT form and an original voided check (if interested).
Mail a notebook to each selected dealer with agreements to put legal relationships into place.
Market the participating portal programs to the dealers; dealer selects preferred portal; facilitate the signing of portal agreements.
If a signed agreement is forwarded to clearinghouse 100, representatives of financing originating system 200 are notified. The dealer is also contacted acknowledging the signed agreement has been received.
The last page of the signed dealer agreement may have the dealers ID number, home bank auction, dealer contact, phone and fax number, and e-mail address written at the top.
The signed dealer agreement is signed by the clearinghouse 100, imaged, and e-mailed to central administration.
The original clearinghouse signed dealer agreement is maintained, imaged and stored.
Once the dealer has been using the program for a minimum time (e.g., two weeks), contact may be made to the dealer to determine if they have any issues. System 100 will continue to “hold their hand” by providing personalized service and support until a minimum (e.g., five) deals are funded.
For dealers whose signed agreements have been received but not “in network” (e.g., credit line too small), send a letter to the dealer with the criteria of enrolling into the program and help facilitate a credit line upgrade or enrollment and notify system 200 of the dealer's status.
   Operation's Process
Once the dealer signs on to the system 200, system 200 verifies their sign on access are checked through system 100 to determine their current standing with the clearinghouse 100. Dealers are able to submit financing applications to lenders only if the DEALERS are in “good standing.”
The dealer submits the customer's loan information through system 200 to obtain financing terms and ultimately agreement from lender to finance loan at terms agreeable to consumer, approval (block 1010, 1012).
Once all parties approve financing terms, information will be transmitted through system 100 for vehicles going through the program (block 1014). The clearinghouse 100 will check the VIN against the database 150.
If vehicle is floored or has been floored with affiliate of clearinghouse 100, then clearinghouse returns an accepted message to system 200. If vehicle has never been floored with affiliate, then the clearinghouse 100 will also return an accepted status to system 200 (block 1016).
Once the dealer selects the lender and the program for their customer and finalizes the deal, the clearinghouse 100 is notified of a loan approved by the dealer and lender (block 1012, 1014).
The disbursement sheet is submitted by system 200 and automatically forwarded to the clearinghouse 100 (block 1020).
The clearinghouse 100 checks any out of network vehicles to determine if they were purchased at an in-network auction (block 1022).
By a certain time (e.g., the fourth business day) from the date the deal was finalized, the clearinghouse will e-mail or fax a list of deals to the lender to determine which deals will be funded, the amount the lender will finance, and the amount that will be forwarded to the clearinghouse 100. This may be an automated function with some portals. Any notification of funding from the lender is provided in writing (some lenders may provide different procedures in obtaining finalization notification).
Once the lender or portal notifies the clearinghouse 100 that the deal will be funded, the clearinghouse 100 will image the approval and notate the account (who authorized funding and the funding amount).
The clearinghouse 100 enters the ‘funding intent’ status in the appropriate account along with the funding amount (if provided). Once this occurs, the clearinghouse 100 will systematically process payment of the dealer's floorplan (if floored by a participating floorplan company).
If the lender advises the deal will not be funded, the clearinghouse 100 closes the deal with the appropriate cancellation status.
The lender has a certain amount of time (e.g., six business days) from the date advised of the loan funding to send clearinghouse 100 the appropriate amount (the lender programs vary—reserves might be paid up-front; others are paid over time).
The clearinghouse 100 will follow-up with the lender for any loan amounts that payment has not been received by a certain time (e.g., sixth business day) from the date they advised the deal would be funded.
Once payment arrives from the lender, clearinghouse 100 posts the amount to the account, the account will automatically be statused as ‘funding received’.
Once the lender's funds have been received, clearinghouse 100 obtains the disbursement sheet and compare the amount listed with the amount received.
Funding received from the lender without clearinghouse 100 receiving their written notification, will be applied to the account and both the ‘funding intent’ status and the ‘funding received’ status will be generated, both having the date the funding was received.
Clearinghouse 100 provides the lender with a monthly invoice for program fees as indicated in their contract.
   In Network Vehicles
Once the lender provides written notification that the deal will be financed and the ‘funding intent’ status has been entered into clearinghouse 100, if the vehicle is “in network” floor planned by an affiliate and having records stored in database 150, the system will calculate the payoff amount and systematically payoff the dealer's line of credit for the sold unit (block 1024).
Clearinghouse 100 pays the dealer's auction through an internal system and places a hold on remaining payoffs (warranty, insurance, sales tax, title and registration fees and dealer profit) until the title, title paperwork, and lender's funds have been received (the timing and order or payment can vary by dealer).
Clearinghouse 100 sends an e-mail to the dealer advising that the payoff has been sent to the auction. The following information can be included: VIN, year, make, model, date and amount paid, and name of auction.
The clearinghouse 100 will cut the check or other electronic payment request.
The payoff is sent by the clearinghouse 100 with a note providing the dealer's name, dealer ID number, VIN, year, make, and model, and advise the auction to forward the title to title system 300.
If the amount sent from the lender (excluding sales tax, warranty, insurance, registration, and state and title fees) is less than the payoff, clearinghouse 100 will pay the entire payoff on behalf of the dealer, and invoice the dealer the amount that the lender's check did not cover.
For any short payoffs, clearinghouse 100 may contact the dealer and advise of them of the shortage. The dealer will have to pay the invoice (e.g., within 48 hours).
If the dealer does not send the payment within the required time frame, the dealer will be deactivated from the clearing system until payment has been received. The dealer's auction house A will also be notified of the outstanding payment.
If title has not been received within a certain time (e.g., three business days), the clearinghouse 100 contacts the dealer's auction house A and determines if they have previously sent the title to Title system 300. If the title was sent to the dealer, the clearinghouse 100 contacts the dealer and have the title mailed to Title system 300.
Once the title has been received by the Title system 300, it will status the account in the system indicating that the title has been received.
   Out of Network Vehicles
Once the lender or portal notifies that the deal will be financed, if the vehicle is not floor planned by a clearinghouse affiliate and is therefore not already in database 150, the clearinghouse 100 contacts the dealer and requests that the title and bill of sale be sent to Title system 300 (block 1028).
For some transactions, clearinghouse 100 may place a hold on all disbursements (warranty, insurance, sales tax, title and registration fees, and dealer profit) until the title, and the title paperwork has been received; however, disbursement of funds varies by dealer.
If the title and/or title paperwork has not been received from the dealer within a certain time (e.g., three business days), the clearinghouse 100 contacts the dealer to determine the location of the title and/or title paperwork.
Once the title and title paperwork has been received by the Title system 300, the title system will status the account within their system indicating that they have been received. This information is conveyed to the clearinghouse 100.
   Title Process (See Blocks 1030-1050)
Title system 300 will receive an e-mail or other automatic notification of new consignment once the account has been placed in ‘funding intent’ status, which will enable it to create purchase orders for vendors requiring payment (e.g. sales tax, title fee, and registration). Payment to their vendors will occur once the title, title documentation, and lender's funds have been received.
Once the title and title paperwork has been received (block 1026), the Title system 300 stores the account and systematically requests a check for payment for sales tax, title, and registration fees. The actual process followed depends on the title and registration laws in each state or jurisdiction.
If the state notifies the Title system 300 that the fees for sales tax, title and registration fees are more than was sent, a new check request will be generated and clearinghouse 100 will invoice the dealer for the remaining amount.
The clearinghouse 100 will receive system notification of the dealer payment and contact dealers who are invoiced due to underpayment for registration fees, sales tax, or title fees by a certain time (e.g., on the fifth business day from the date the invoice was mailed) to follow-up for payment.
The dealer will have to send in payment within a certain time (e.g., five business days).
If the dealer does not send the payment within the required time frame, the dealer will be deactivated from the system until payment has been received and the dealers' auction house A is notified of the outstanding payment owed.
If the state provides title system 300 with a check for overpayment for sales tax, title, and registration fees, the overage amount is sent to the dealer for them to forward to the customer.
The title application is completed electronically.
The title application is sent to the state and the title system 300 will status the clearinghouse 100 with an estimated date the customer should receive their vehicle registration and the lender should receive the new title.
Once the estimated date has expired, the title system 300 will follow up with the Department of Motor Vehicles (DMV) to determine if the registration has been mailed to the customer. The title representative will also contact the customer to ensure their vehicle's registration has been received.
Once the state's DMV's office generates a new title (required by some states), the title is overnighted to the appropriate lien holder.
The title system 300 will forward a weekly spreadsheet to each lender once the estimated receiving time has expired. The lenders are to verify receipt of titles and notify the title system 300 if they have or have not received the title. The lender is to send a copy of the titles they have received to the Title system 300.
If the lender has not received the title, the title system 300 will contact the appropriate DMV office for follow up.
Once the copy of the title has been received, the title system 300 verifies that the title has been completed correctly.
If the title is not correct, the title system 300 will contact the lender for the original title and forwards it to the appropriate DMV office to pursue a corrected title.
If the title is correct, the account is closed in the title system 300.
   Exemplary Description of Operations of Non-Limiting Illustrative Title System 300

The following describes in more detail some exemplary aspects of functions and operations performed by a non-limiting illustrative implementation of title system 300.

Exemplary resources and tools used to process title and registration paperwork for DAFS deals include:
Knowledge of state by state title, state filing form requirements, registration, and sales tax payment responsibilities and fees complied in a continually updated list
Network of title professionals located in respective states providing professional title and registration direct “walk-in” service in states in which efficiency is enhanced
Automated title system enabling status updates to be communicated along with the ability to track every aspect of the title and paperwork process from knowledge of consignment to the completion of the registration and title transfer including lien perfection
Developed infrastructure of title professionals with extensive experience that manage the day-to-day operations, monitor the step-by-step title and registration process, and oversee the network of title professionals performing fieldwork

Exemplary Non-Limiting Deal By Deal Title & Registration Process:
Record the contract date
Monitor deals in progress to submit title documents to the respective state within 20 days of the contract
Gather all state specific supporting title documentation required to accompany the title during ownership transfer
Call the DMV to verify costs for title, registration, and sales tax, (where applicable) for the program vehicle
Lender lien perfection information is included on the title paperwork submitted to the respective state
Ensure that newly issued titles including lien perfection, are delivered to the respective program lender within 90 days of receipt of loan proceeds.
Lien holders are contacted to ensure receipt of title containing accurate information and lien perfection

While the example shown is in connection with auctions for automobiles, the system and/or process could be used for any other type of goods, any type of dealer and any type of lender.

While the clearinghouse 100 and lender matching engine 200 are described herein as being different computers and/or entities, such functionality could be combined into a single computer and/or entity if desired. While it may be advantageous for the entity that operates clearinghouse 100 to have an association with auction houses A, such relationship is not necessary in other exemplary implementations. Any or all of the functions described herein can be performed automatically by computer.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A method of mitigating risk in financial transactions relating to automobile purchases, comprising:
establishing relationships with automobile dealers;
at least in part through said relationships, collecting and evaluating information concerning said automobile dealers;
based at least in part on said collecting and evaluating, determining whether further transactions with a particular dealer entail unacceptable risk; and
at least in part through the use of a computer, automatically conditioning access by said particular dealer to financing options substantially in real time response to said determining.

2. The method of claim 1 wherein said determining includes setting a good standing status flag.

3. The method of claim 1 wherein said access conditioning comprises revoking loan origination portal password privileges.

4. The method of claim 1 wherein said access conditioning comprises restricting dealer access to a subset of financing options.

5. The method of claim 1 further including supplying inventory to said dealers through said relationships.

6. The method of claim 1 further including providing intermediate financing to said dealers for unsold inventory.

7. The method of claim 1 further including processing loan payoffs.

8. The method of claim 1 further including perfecting liens against inventory.

9. The method of claim 1 further including guaranteeing title.

10. The method of claim 1 further including securing title.

11. The method of claim 1 further including verifying trade-in payoff.

12. The method of claim 1 further including serving as loan escrow agent.

13. The method of claim 1 further including communicating with a dealer management system on said particular dealer site to collect information concerning said particular dealer.

14. The method of claim 1 further including transmitting payments over an electronic payment network.

15. A system for mitigating risk in financial transactions relating to automobile purchases, comprising:
establishing relationships with automobile dealers;
a data collector that collects and evaluates information concerning said automobile dealers at least in part through said relationships;
an evaluator that evaluates, based at least in part on said collecting and evaluating, whether further transactions with a particular dealer entail unacceptable risk; and
a loan origination portal computer coupled to said evaluator, said loan origination portal computer automatically conditioning access by said particular dealer to financing options substantially in real time response to said determining.

16. The system of claim 15 wherein said evaluator sets a good standing status flag

17. The system of claim 15 wherein said portal computer revokes loan origination portal password privileges.

18. The system of claim 15 wherein said portal computer restricts dealer access to a subset of financing options.

19. The system of claim 15 further including an auction computer that manages supply of auction inventory to said dealers through said relationships.

20. The system of claim 15 further including means for providing intermediate financing to said dealers for unsold inventory.

21. The system of claim 15 further including means for processing loan payoffs.

22. The system of claim 15 further including means for perfecting liens against inventory.

23. The system of claim 15 further including means for guaranteeing title.

24. The system of claim 15 further including means for securing title.

25. The system of claim 15 further including means for verifying trade-in payoff.

26. The system of claim 15 further including means for serving as loan escrow agent.

27. The system of claim 15 further including means for communicating with a dealer management system on said particular dealer site to collect information concerning said particular dealer.

28. The system of claim 15 further including means for transmitting payments over an electronic payment network.
